(19) United States
(12) Patent Application Publication
(10) Pub. No.: US 2014/0348609 A1
(43) Pub. Date: Nov. 27, 2014

(54) FASTENING ASSEMBLY

(71) Applicants: Patien CHEN, (US); Perfect Power Technology Co., Ltd., Kaohsiung City (TW)

(72) Inventor: Patien CHEN, Kaohsiung City (TW)

(73) Assignee: Perfect Power Technology Co., Ltd., Kaohsiung City (TW)

(21) Appl. No.: 13/902,043

(22) Filed: May 24, 2013

(51) Int. Cl. F16B 39/12

(52) U.S. Cl. CPC F16B 39/12
USPC 411/209

(57) ABSTRACT

A fastening assembly, comprising a nut and a washer, where the nut is provided with a threaded hole and a nut head, the nut head forms plural consecutive ramps. The threaded hole forms a barrier surface. The washer has a through hole and an diameter-enlarged hole, and the through hole and the diameter-enlarged hole form a shoulder at their junction. The washer is provided with consecutive ramps with the same number as that of the continuous ramps of the nut. The barrier surface of the nut confines the shoulder of the washer that the washer is not allowed to separate from the nut. The nut and washer can be relatively free to rotate, so that the two will not result in deadlocked state prior to their actual usage, to ensure that the anti-theft and locking features achieve the goal of preventing the illegal theft and destruction.

### BACKGROUND OF THE INVENTION

1. Field of the Invention

The present invention relates to a fastening assembly, especially a fastening assembly of a nut and a washer that features anti-theft and locking.

2. Description of the Prior Art

In order to prevent the loosening of the nuts and the bolts after fastening one with the other due to factors such as vibration, pulling and the like, or to prevent the situations of non-user allowance as stealing and injury, and there is already a variety of conventional solutions, such as the U.S. Publication No. 200710243040A1, U.S. Pat. No. 5,626,449, U.S. Pat. No. 4,168,731, U.S. Pat. No. 4,034,788, U.S. Pat. No. 4,055,208, and R.O.C. N ovel No. M298660, No. 298,661, No. 298,662, No. 293,986, Patent No. 285,634, which disclose roughly a means of preventing the loosening after the nut has been tightened by the creation of corresponding radial consecutive ramps on the nut and the washer, however, the prior means still reveal problems to be solved; for instance, the nut and the washer are separated from each other, and the false installation of the direction of the washer due to inadequate training or negligence of the handling members, which fail the features of anti-theft and locking of the original design, accordingly, ROC Patent No. 1277701 discloses a fastener of anti-theft and locking assembled by a nut and a washer, where the nut and the washer are not separable one with the other, to avoid the occasions of the false installation of the direction of the washer by the handling members, how ever, the structure s till has structural problems which result in failure to achieve the purpose of locking and anti-theft after installation. To comprehend in detail why the conventional structure is unable to achieve the above objectives, the description is as follows:

Referring to FIGS. 1 & 2, the figures are three-dimensional exploded views of a prior anti-theft and locking fastener viewing from different angles, and the prior anti-theft and locking fastener comprises a nut 40, having a threaded bore 401, and its bottom edge forms an outward expanding disc 41, the bottom surface of the disc 41 is set up with a plurality of wedge slants 44, while each wedge slant 44 connects one with the next successively and forms a baffle 441 at the intersection due to the drop of high and low wedge slants 44. The disc 41 is provided with three notches 42, the bottom surface adjacent to the threaded bore 401 forms downward extending flange rim 43; a washer 50, having a hole 52, and the washer 50 is set up with plural consecutive ramp 53 on its top surface, where each of the consecutive ramps 53 connects one with the other successively and forms a jog 531 at the intersection due to the drop of high and low consecutive ramp 53, the top of the hole 52 has a bump 55 formed by reducing diameter from the hole 52. The washer 50 is provided with three notches 54. As the nut 40 combines with the washer 50, the notches 54, 42 are aligned one with the other, which allows the poles of a special tool to insert into the notches 54, 42 for the dismounting.

Please refer to FIGS. 3 & 4, FIG. 3 is an assembled top view of a prior anti-theft and locking fastener, and FIG. 4 is a sectional view along the line AA direction based on FIG. 3. The disc 41 at the bottom of the nut 40 is placed on the top of the washer 50. As the flange rim 43 of the bottom surface of the nuts 40 is inserted into the hole 52 of the washer 50 and passes it through, the flange edge 43 is bent outwardly to form an annular wall 431 by pressing and the like, the annular wall 431 is held by the bump 55 at the bottom of the washer 50, which barricades the washer 50 to escape from the bottom of the nut 40.

The prior anti-theft and locking fastener is indeed able to prevent the occasions that general thieves use an ordinary wrench to loosen the nut 40 by means of the pushing principle between the wedge slant 44 and the consecutive ramp 53; however, once there is an error in the fabrication process or the removal of the nuts in the future once again, the notches 42, 54 are set up, and a special wrench with three poles that ordinary people can scarcely obtain. By the insertion of the three poles into the notches 42, 54 and with the rotation to the nut 40 and washer 50, the fastener can then be smoothly loosened due to the prevention of pushing one with the other by the wedge slants 44 and the consecutive ramp 53. In order to achieve the purpose of the removal of the nut once again, the notches 42, 54 must remain aligned for the accommodation of the insertion by the poles of special tools.

In order to allow the notches 42, 54 to remain in alignment, the notches 42, 54 must be aligned first during the assembly of the nut 40 and the washer 50, and the notch 42, 54 must not be misaligned after the riveting of nut 40 and the washer 50. Please refer to FIG. 4, the nut 40 and washer 50 are in a combined state while the wedge slant 44 and the consecutive ramp 53 are in fully match and the baffle 441 and the jog 531 are also in fully match. For the time being, if the nut 40 is set apart from the washer 50 for higher than the vertical height a of the top and the bottom of the ramp, the nut 40 and the washer 50 have the opportunity to rotate relatively to each other which mismatches between the notch 42 and the notch 54 that fails to align. In order to avoid such a situation to occur, the moment that the flange rim 43 is bent to form an annular wall 431, the vertical gap b between the annular wall 431 and the bump 55 is deliberately limited to less than the aforementioned vertical height a.

Although the way to limit the vertical gap b less than the vertical height a may assure an alignment between the notch 42 and the notch 54, another problem in actual comes out. The nut 40 and the washer 50 will rotate reversely one with the other because of vibration, friction and pushing to each other during the transportation, which brings about a sliding along the contact between the wedge slant 44 and the consecutive ramp 53. Once the annular wall 431 touches the bump 55, the wedge slant 44 and the consecutive ramp 53 proceed to press tightly to each other due to vibration, friction and pushing. Additionally, the long er storage time and the oxidation of the moisture in the air will ultimately give rise to a deadlock as shown in FIG. 5, that is, the nut 40 and the washer 50 have become a unity which is unable to move relatively to each other. When the deadlocked fastener is screwed into the bolt by a handling member, the deformation distance c will be left very small amount which prevents the nuts 40 to exit, and the contact area between the wedge slant 44 and the consecutive ramp 53 is also smaller than that of the original design and is easily deformed. As the nut 40 is toppled by an ordinary wrench at the moment, the consecutive ramp 53 is likely being oppressed by the wedge slant 44 into deformation that enables a rotation, the nut 40 is therefore loosened irregularly.

In summary, these prior anti-theft and locking fasteners still have such problems as not effectively prevent the theft and destruction, and the prior art did not reveal any means of settlement.

### SUMMARY OF THE INVENTION

In accordance with an embodiment of the present invention, a fastening assembly is proposed, comprising a nut and a washer, the lower edge of the nut head of the nut expands outwardly to form a skirt portion, and the bottom of the skirt portion is provided with plural consecutive ramps, where adjacent consecutive ramps form a bulkhead in between. The bottom of the threaded hole of the nut extends downwardly to form a blocking ring, and the outer edge of the blocking ring forms a barrier surface toward the surface of the consecutive ramps. The washer has a through hole at its center, and one part of the through-hole is enlarged to form a diameter-enlarged hole, where the through hole and the diameter-enlarged hole form a shoulder at their junction. A top surface of the washer is provided with the same number of consecutive ramps as the consecutive ramps of the nut, and adjacent consecutive ramps form a bulkhead in between; the maximum vertical distance from the barrier surface to the shoulder is greater than the vertical height of the bulkhead. Therefore, the barrier surface of the nut confines the shoulder of the washer that the washer is not allowed to separate from the nut, while the nut and washer can be relatively free to rotate, so that the two will not result in deadlocked state prior to their actual usage, to ensure that the use of it is able to achieve the goal of preventing the illegal theft and destruction.

### BRIEF DESCRIPTION OF THE DRAWINGS

FIG. 1 is a three-dimensional exploded view of a prior anti-theft and locking fastener viewing from the first angle;

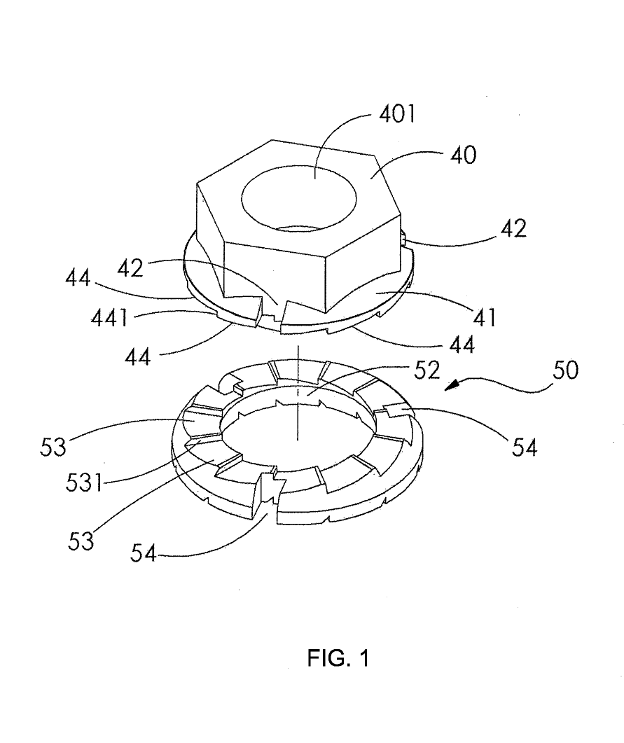

FIG. 2 is a three-dimensional exploded view of a prior anti-theft and locking fastener viewing from the second angle;

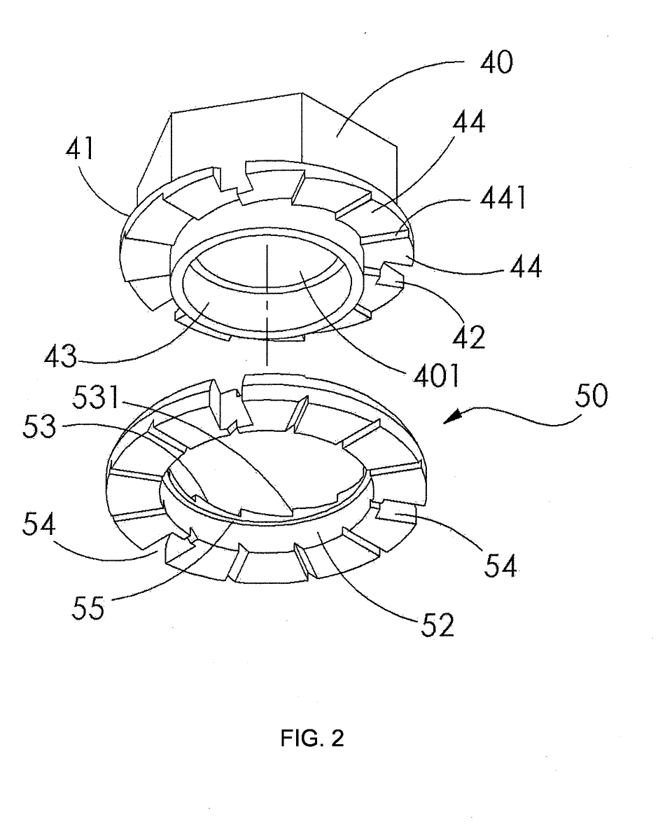

FIG. 3 is an assembled top view of a prior anti-theft and locking fastener;

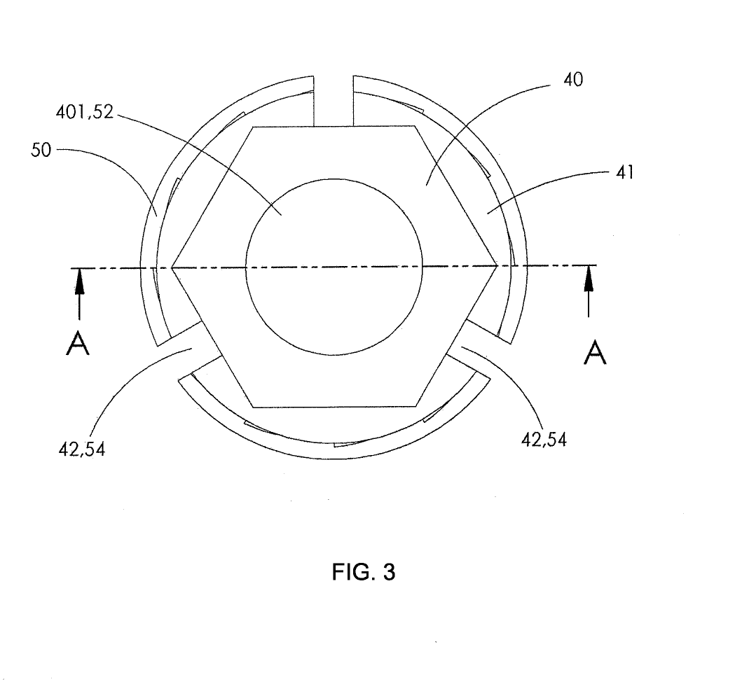

FIG. 4 is a sectional view along the line AA direction based on FIG. 3;

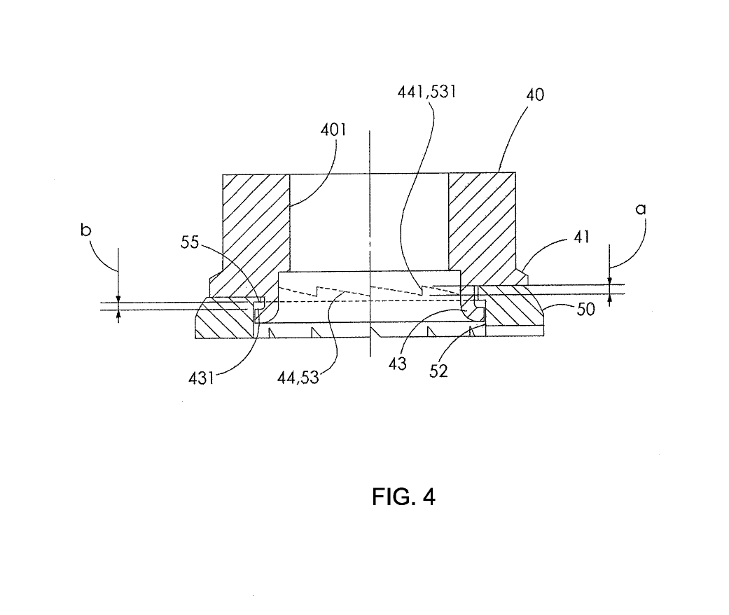

FIG. 5 is a state schematic diagram of deadlock after a prior anti-theft and locking fastener is assembled;

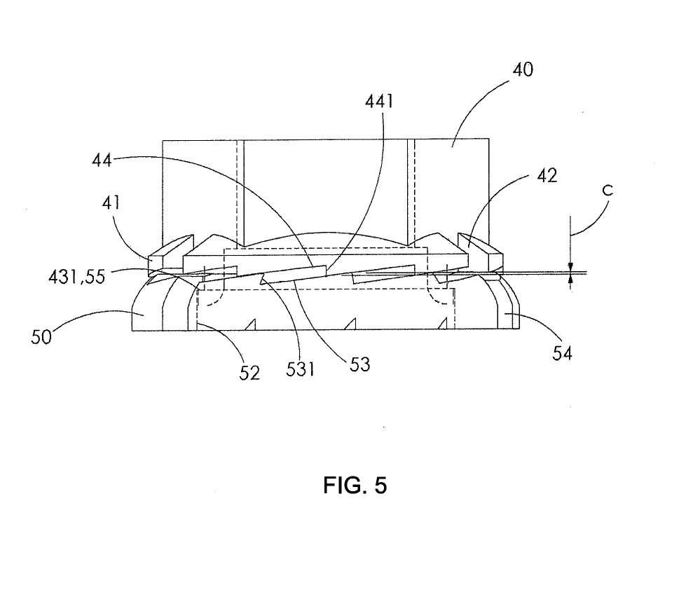

FIG. 6 is a three-dimensional exploded view of the present invention;

FIG. 7 is a three-dimensional exploded view of FIG. 6 in another direction;

FIG. 8 is a three-dimensional assembled view of a first embodiment of the present invention;

FIG. 9 is a cross-sectional assembled view of the first embodiment of the present invention;

FIG. 10 is a three-dimensional assembled view of a second embodiment of the present invention;

FIG. 11 is an assembled top view of the second embodiment of the present invention; and

FIG. 12 is a sectional state schematic diagram of using along the line BB based on FIG. 11.

### DETAILED DESCRIPTION OF THE INVENTION

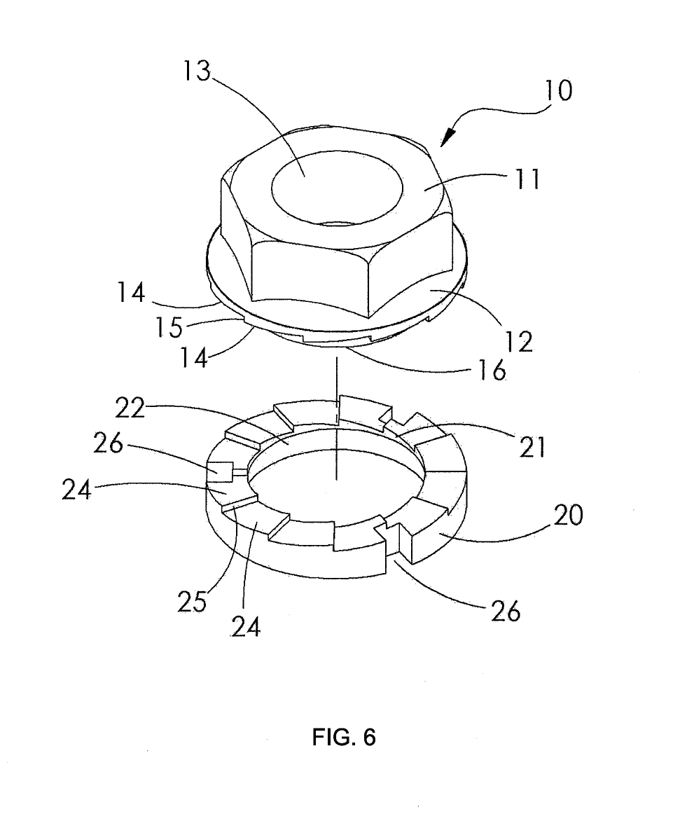

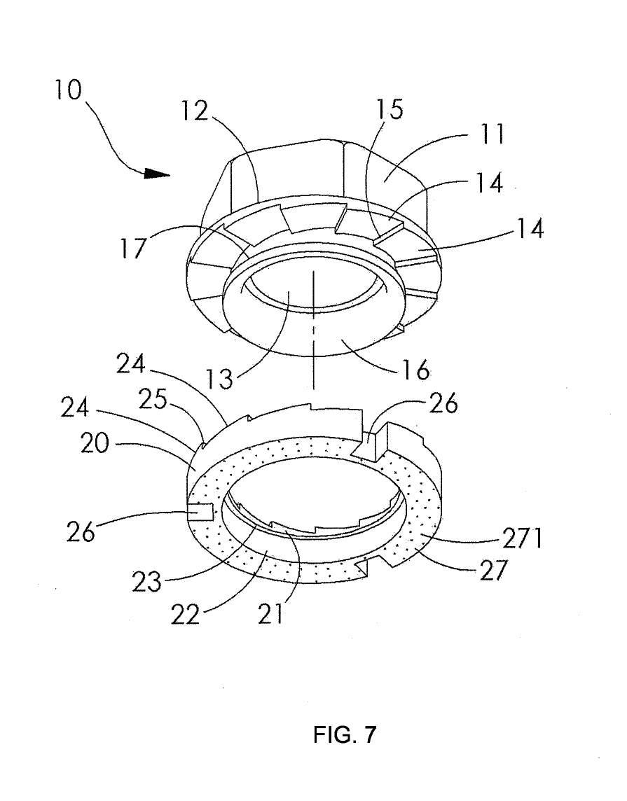

Please also refer to FIGS. 6 & 7; these two figures are three-dimensional exploded views in different direction based on a first embodiment of the present invention. The fastening assembly of the present embodiment comprises a nut 10 and a washer 20, where the nut 10 has a nut head 11, and the ordinary nut head of the nut has a shape with a variety of different specifications and outlines. The nuts represented in the drawings is a six-sided cylinder but not limited to such kind of a hexagonal nut. The lower edge of the nut head 11 extends outwardly into a disk-shaped skirt portion 12, and the skirt portion 12 in turn enlarges the covered area of the cap head 11. The center of the nut 10 has a threaded hole 13, and the type of threads can choose from triangular thread, standard thread or trapezoidal thread; however, the threaded teeth are not drawn in detail in the figures. The bottom of the skirt portion 12 is set up with a plurality of consecutive ramps 14, where the number of the consecutive ramps 14 is at least 3, and most preferably 10 to 15. Each of the consecutive ramps 14 has the same length and inclination angle, and the adjacent consecutive ramps 14 form a bulkhead 15 in between. The bottom of the threaded hole 13 extends downwardly into a blocking ring 16, where the inner diameter of the blocking ring 16 is larger than that of the threaded outer diameter of the threaded hole 13, so that the threaded hole 13 are not interfered with the bolt during the screwing together with the bolt. The blocking ring 16 shown in FIG. 7 is a deformed shape after assembly, and the outer edge of the deformed blocking ring 16 forms a barrier surface 17 toward the surface of the consecutive ramps 14. The washer 20 is an annular body, where its outer diameter is less than or equal to the maximum outer diameter of the skirt portion 12. The center of the washer 20 has a through hole 21, and the diameter of a part of the through hole 21 is enlarged to form a diameter-enlarged hole 22. The junction of the through hole 21 and the diameter-enlarged hole 22 forms an annular planar shoulder 23. The top of the washer 20 is provided with a plurality of consecutive ramps 24, while the number of the consecutive ramps 24 is the same with that of the consecutive ramps 14 of the nut 10. Each of the consecutive ramps 24 has the same length and inclination angle while the adjacent consecutive ramps 24 form a bulkhead 25 in between. The outer circumferential surface of the washer 20 is provided with at least one notch 26, and the optimal number of the notches 26 is three which is equally spaced. The washer 20 has a bottom surface 27, and the bottom surface 27 is used to contact with the object to be fixed, where its surface is provided with fine texture structures 271. The fine texture structures 271 are selected as slightly raised or slightly recessed points or lines, with a preferred range of 0.1˜0.3 mm. During the screwing upon the fastened objects, the fine texture structure 271 can produce tiny deformations which increase friction, and won't bring about scratching to the surface of the fastened objects.

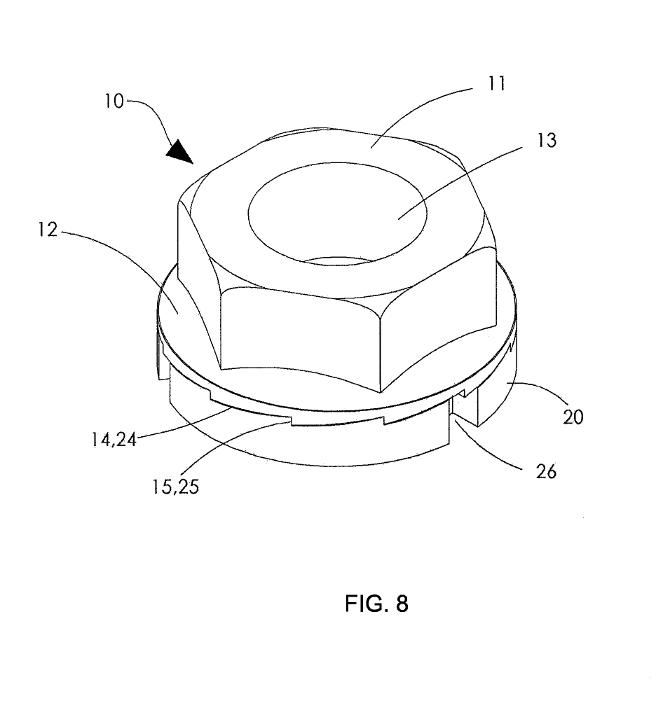

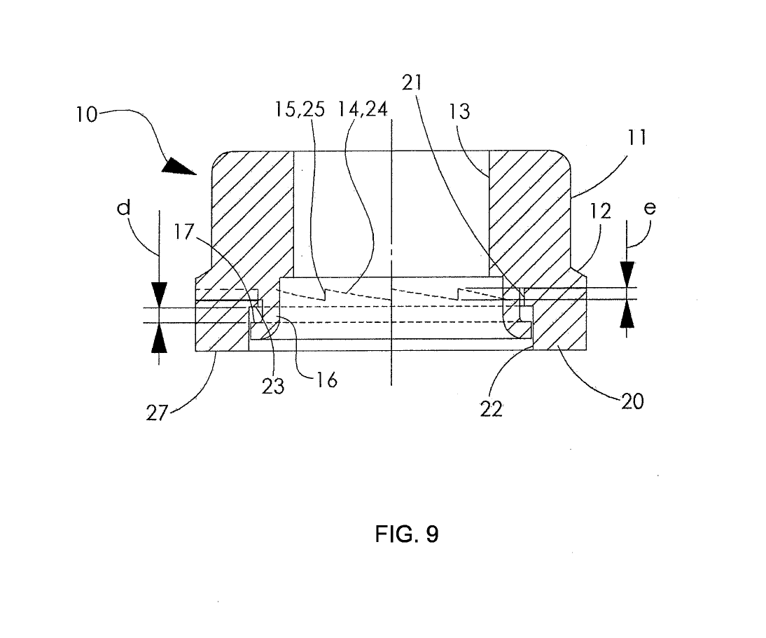

Please refer to FIGS. 8 & 9. FIG. 8 is a three-dimensional assembled view of a first embodiment of the present invention, and FIG. 9 is a cross-sectional assembled view of the first embodiment of the present invention. Once the nut 10 and washer 20 are combined, the consecutive ramps 14, 24 of the two are closely bonded, while the bulkheads 15, 25 are also in a contact state, and the skirt portion 12 forms a covering on the notch 26. The blocking ring 16 of the nut 10 is a straight tube in shape (not shown) before combining with the washer 20, while the blocking ring 16 shown in the figure has been deformed into a flared-type outwardly enlarged diameter, and is formed into a barrier surface 17. The means to deform the blocking ring 16 is generally the stamping. According to the latest industrial techniques, molds can be used to very precisely control the amount of deformation and the deformation size. The barrier surface 17 formed by the outer diameter of the deformed blocking ring 16 blocks the shoulder 23 of the washer 20. Once the washer 20 and the nut 10 are under the most close state (i.e., the state of contact between bulkheads 15, 25 shown in FIG. 9), the vertical distance d between the barrier surface 17 and the shoulder 23 is greater than the vertical height e of the bulkheads 15, 25, that is, the maximum distance of the barrier surface 17 and the shoulder 23 is greater than the vertical height of the bulkheads 15, 25. In this way, the washer 20 is unable to be detached from the bottom of the nut 10, and the washer 20 and the nut 10 can rotate relatively to each other. A consecutive ramp 14 can easily slip through any consecutive ramp 24 in the vibration environment during delivery, and the washer 20 and the nut 10 won't be deadlocked by the two ramps. As a result, the washer 20 will not be departed from the nut 10, and no reverse direction in placing the washer 20 during fastening. Next, because the consecutive ramps 14, 24 will not be locked during fastening, so the wrench is used to rotate the nut 10, and through the bulkhead 15 to press the bulkhead 25, the washer 20 is rotated to lock into place. Furthermore, due to the notch 26 is covered by the skirt portion 12, under the circumstance that the illegal vandals couldn't obtain the controlled special tools, what they can use is only an ordinary wrench to unscrew the nut 10 counterclockwise. Because of the fine texture structures 271 on its bottom surface 27 that can increase friction between it and the fixed object, the washer 20 will not keep up with the rotation of the nut 10. The consecutive ramps 14, 24 are pushing one with the other, which leads to that the threads of the threaded hole and the threads of the bolt (not shown) get more tight as they turn more, provided that the applied torque completely destroys the thread structure, otherwise the nut 10 couldn't be unloaded.

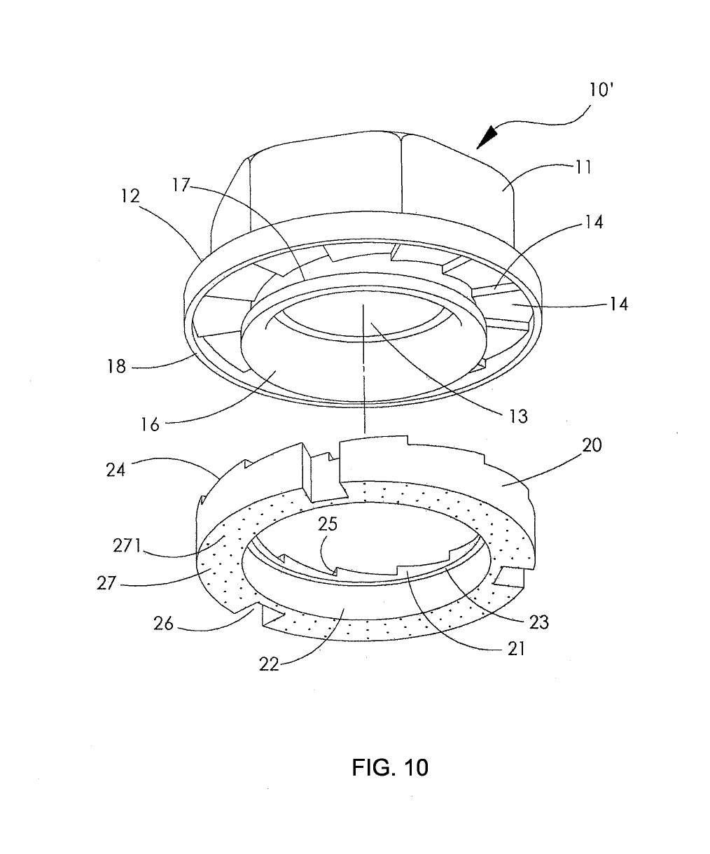

Please refer to FIG. 10. FIG. 10 is a three-dimensional assembled view of a second embodiment of the present invention. The fastening assembly of the embodiment comprises a nut 10′ and a washer 2Q, where the nut 10′ has a nut head 11, and the lower edge of the nut head 11 is outwardly expanded into a disk-shaped skirt portion 12, while the skirt portion 12 expands the covered area of the nut head 11 and the outer circumferential surface of the skirt portion 12 further extends downwardly to form a fence 18. The center of the nut 10′ is provided with a threaded hole 13. The bottom of the skirt portion 12 is set up with a plurality of consecutive ramps 14, and the number of the continuous ramp 14 has at least three, most preferably 10 to 15. Each of the successive ramps 14 has the same length and inclination angle while the adjacent continuous ramps 14 form a bulkhead 15 in between. The fence 18 can completely cover the consecutive ramps 14 and the bulkheads 15 completely from the lateral. The bottom of the threaded hole 13 extends downwardly to form a blocking ring 16, and the inner diameter of the blocking ring 16 is greater than the outer thread diameter of the threaded hole 13, while the outer edge of the blocking ring 16 and the consecutive ramp 14 form a barrier surface 17 in between. The washer 20 is an annular body, and its outer diameter is smaller than the inner diameter of the fence 18. The center of the washer 20 has a through hole 21, and a part of the through hole 21 is set up with enlarged diameter which forms a diameter-enlarged hole 22. The junction of the through holes 21 and the diameter-enlarged hole 22 forms an annular planar shoulder 23. The top of the washer 20 is provided with a plurality of consecutive ramps 24 with the same number as that of the continuous ramps of the nut 10′, and each of the consecutive ramps 24 has the same length and the inclination angle while adjacent consecutive ramps form a bulkhead in between. The outer circumferential surface of the washer 20 is provided with at least one notch 26, and the optimal number of the notches 26 is three which is equally spaced. The washer 20 has a bottom surface 27, and the bottom surface 27 is used to contact with the object to be fastened, where its surface is provided with fine texture structures 271. The fine texture structures 271 can be slightly raised or slightly recessed points or lines with a preferred size in the range of 0.1˜0.3 mm. During the pressing upon the fastened objects, the fine texture structures 271 are able to produce tiny deformations which increase friction, and won't bring about scratching to the surface of the fastened object.

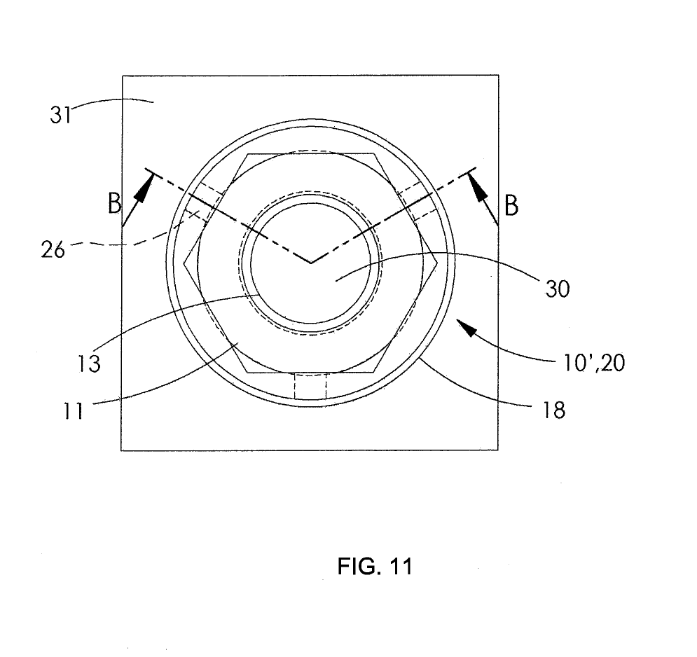

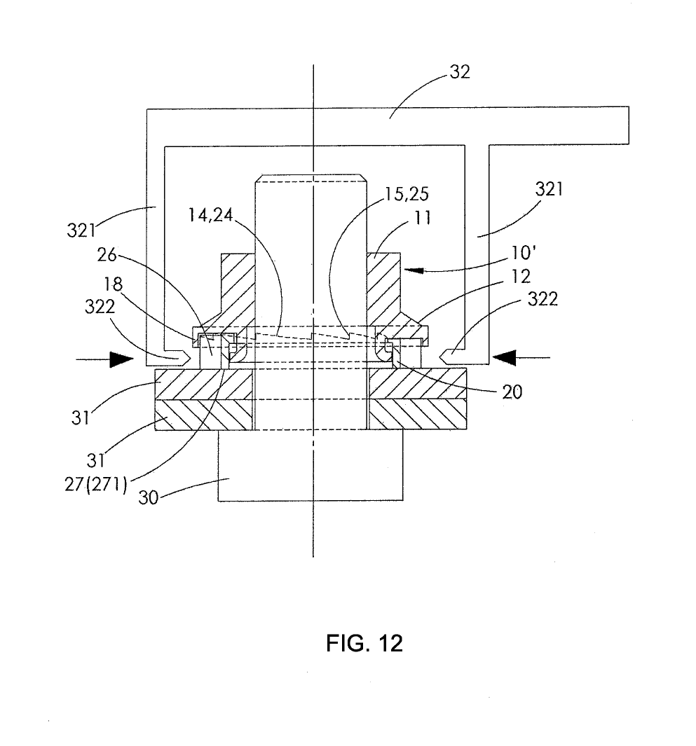

Please refer to FIGS. 11 & 12. FIG. 11 is an assembled top view of a second embodiment of the present invention. FIG. 12 is a sectional state schematic diagram of using along the line BB based on FIG. 11. The nut 10′ and the washer 20 are fastened to two fixing objects 31 by a bolt 30. The bottom surface 27 of the washer 20 contacts the surface of one of the fixing objects 31, and the fine texture structures 271 enables the washer 20 and the surface of the contacted fixing object 31 to have more friction that can overcome a larger torque. There is a completely fit between the consecutive ramps 24 of the washer 20 and the consecutive ramps 14 of the nut 10′. The bulkheads 15, 25 are close together. The skirt portion 12 covers the notched 26 in the axial position, which avoids ordinary tools to directly insert into the notch 26. The fence 18 further encloses the lateral of the consecutive ramp 14, 24 so that others couldn't see from the appearance that the fastener features anti-theft and locking. As the illegal vandals try to unscrew the fasteners, with an ordinary wrench to exert a torque toward the nut head 11 for stripping the nut 10′, or due to vibration or pulling, which leads to the rotation to the unscrewing direction of the nut 10′. And the consecutive ramps 14 and 24 will in turn push to each other such that the threads of the nut 10′ and the threads of the bolt 30 could produce a great contact friction to prevent the nut 10′ to unscrew. Because such fasteners are typically used for fixing rails or assembling steel structure construction, its mechanical threads themselves have a larger steel rigidity which may resist fracture and destruction, and nut 10′ couldn't be unscrewed that achieves the purpose of the anti-theft and locking.

Once the regular users have to unscrew the locked fastener during working due to procedural errors and the like, a removal tool 32 is used to lift the locked fasteners, where the tool 32 is provided with plural poles 321 with the same quantity and aligned position to those of the notches 26. The pole 321 has a claw 322 at its far end, where the claw 322 can be moved crosswise relative to the pole 321, and the ways to move can be accomplished by the screwing in and out of the thread or by the stretching of the spring. The detailed structure of the tool is not described hereat. As the pole 321 of the removal tool 32 is placed into the corresponding notch 26, the claw 322 is placed into the notch 26, followed by rotating the removal tool 32 that enables the claw 322 to drive the washer 20 to rotate. The washer 20 is driven by the pressing between the bulkhead 25 and the bulkhead 15, which forces the cap 10′ to rotate synchronously, and the consecutive ramps 14, 24 won't produce pressing between the ramps, and thus the fastener can be smoothly unscrewed.

All of the disclosed embodiments of the present invention are considered to be illustration instead of limitation to the present invention; the present invention may be described in other ways different from that set forth herein. Therefore, in the case without departing from the scope and essential characteristics of the present invention, in the patenting range of significance and all the changes in the equalization within are deemed to be included in the scope of rights.

1. A fastening assembly, comprising:
a nut, said nut comprising a threaded hole and a nut head, a lower edge of the nut head expanding outwardly to form a skirt portion, and a bottom surface of the skirt portion being provided with a plurality of consecutive ramps, where adjacent consecutive ramps form a bulkhead in between, a bottom of the threaded hole extending downwardly to form a blocking ring, and an outer edge of the blocking ring forming a barrier surface toward a surface of the consecutive ramps;
a washer, said washer being an annular body, where its outer diameter is less than or equal to an outer diameter of the skirt portion, said washer having a through hole at its center, a part of the through hole expanding to form a diameter-enlarged hole, the through hole and the diameter-enlarged hole forming a shoulder at their junction, a top surface of said washer being provided with a plurality of consecutive ramps, the number of the consecutive ramps being the same with that of the consecutive ramps of said nut, adjacent consecutive ramps forming a bulkhead in between, an outer circumferential surface of said washer being provided with at least one notch, wherein
the barrier surface of said nut confines the shoulder of said washer that said washer is not allowed to separate from said nut, the maximum vertical distance from the barrier surface to the shoulder being greater than the vertical height of the bulkhead.

2. The fastening assembly as claimed in claim 1, wherein the notches are concealed by the skirt portion in the axial direction.

3. The fastening assembly as claimed in claim 2, wherein said washer is provided with a bottom surface, and the bottom surface being set up with fine texture structures.

4. The fastening assembly as claimed in claim 3, wherein the fine texture structures are slightly raised or slightly recessed points or lines.

5. The fastening assembly as claimed in claim 4, wherein the fine texture structures have a size in the range between 0.1˜0.3 mm.

6. The fastening assembly as claimed in claim 2, wherein the number of the notches is three.

7. The fastening assembly as claimed in claim 6, wherein the outer circumferential surface of the skirt portion extends downward to form a fence.

8. The fastening assembly as claimed in claim 7, wherein the fence covers the nut and the consecutive ramps and bulkheads of the washer from the lateral.

9. The fastening assembly as claimed in claim 5, wherein the number of the notches is three.
